(19) United States
(12) Patent Application Publication
(10) Pub. No.: US 2021/0357573 A1
(43) Pub. Date: Nov. 18, 2021

(54) SYSTEMS AND METHODS FOR DIGITAL DOCUMENT TOOLS

(71) Applicant: Web Development Done Right, LLC, Pocatello, ID (US)

(72) Inventor: Brett Jameson, Arimo, ID (US)

(21) Appl. No.: 17/317,802

(22) Filed: May 11, 2021

Related U.S. Application Data
(60) Provisional application No. 63/024,732, filed on May 14, 2020.

(51) Int. Cl. G06F 40/106; G06F 16/93; G06F 40/14

(52) U.S. Cl. CPC G06F 40/106; G06F 40/14; G06F 16/93

(57) ABSTRACT

This disclosure relates to computer implemented systems and methods for designing digital documents. The system including a set of instructions to cause at least one processor device and related data processing apparatus to operate to provide a resource module that enables extraction of individual elements of digital resources and storage of the extracted individual elements for use in a design layout, a layout module that enables creation of the design layout in a user-customizable manner using design blocks, an assignment module that enables assignment of the individual elements to the design blocks to create a design layout, and a document creation module that enables the exportation of the design layout to a selectable file format or a selectable medium.

### CROSS-REFERENCE TO RELATED APPLICATIONS

This application, under 35 U.S.C. § 119, claims the benefit of U.S. Provisional patent application Ser. No. 63/024,732 filed on May 14, 2020, and entitled “Systems And Methods For Web Development Tools,” the contents of which is hereby incorporated by reference herein.

### FIELD OF THE DISCLOSURE

This disclosure relates generally to systems and methods for implementing digital document tools. In particular, this disclosure relates to systems and methods for enabling existing digital resources to be redesigned and/or restructured and output as a new document.

### BACKGROUND

Digital documents, as used herein, means any processor-based display of information including, but not limited to, computer-aided design (CAD) files, database files, desktop publishing files (e.g., Adobe Illustrator, PDF, Word, etc.), document files (e.g., plain text, Google drive files, etc.), financial records (e.g., TurboTax, Quicken, etc.), graphics files (e.g., jpg, gif, tiff, ico, bmp, png), Adobe photoshop, 3D graphics, and Vector graphics files (e.g., psd, ai, svg, stl, obj, fbx, etc.), presentation files (e.g., Power Point, etc.), scientific data (e.g., graphs, charts, tables, etc.), spreadsheet/tabular data (e.g., Excel, csv, etc.), audio files and audio tracks (e.g., way, mp3, mp4, etc.), video data files (e.g., mov, avi, mpg, etc.), Web page data (e.g., URLs, images, text, etc.) and the like. Digital documents often need to be revised, redesigned, updated, edited, or otherwise changed (collectively and individually referred to herein as “design” in the appropriate tense). Current systems and methods for designing typically require “manual” or line-by-line, element-by-element changes to be made to the digital document. Such design procedures can be time-consuming, inefficient, and are prone to errors. Other drawbacks, inefficiencies, and issues also exist.

### SUMMARY

Accordingly, disclosed embodiments address the above-noted drawbacks, inefficiencies, and issues. Disclosed embodiments for digital document design provide mechanisms and methods whereby existing digital resources can be designed. One or more digital resources (as used herein meaning webpage URLs, files, images, databases, videos, audio files, data, and the like) may be provided and the system extracts any elements found therein that can be represented within a digital document, such as a website or other digital document (e.g., images, text blocks, links, section headers, etc.). Extracted elements are presented to a system user so they can then be assigned to areas within a new target document structure. Once design is completed, the newly designed document can then be saved/exported out to the target file format/medium (html, pdf, word document, flyer, printout, etc.).

Disclosed embodiments include a computer implemented system for designing digital documents, the system comprising a set of instructions to cause at least one processor device and related data processing apparatus to operate to provide a system comprising a resource module that enables extraction of individual elements of digital resources and storage of the extracted individual elements for use in a design layout, a layout module that enables creation the design layout in a user-customizable manner using design blocks, an assignment module that enables assignment of the individual elements to the design blocks to create a design layout, and a document creation module that enables the exportation of the design layout to a selectable file format or a selectable medium.

In further disclosed embodiments, the digital resources further comprise HTML-based documents. In still further disclosed embodiments, the digital resources further comprise word-processor documents. In further disclosed embodiments, the digital resources further comprise one of computer-aided design files, database files, desktop publishing files, document files, financial records, graphics, 3D graphics, vector graphics files, photoshop files, presentation files, scientific data, spreadsheet/tabular data, audio files, video files, or web page data, and the like.

In some disclosed embodiments, the design blocks are user-customizable.

In some disclosed embodiments, the design blocks further comprise sub-areas that may be assigned an individual element.

In some disclosed embodiments, selectable data may be assigned, using the assignment module, to a graph design block. In further disclosed embodiments, the graph design block comprises a bar-graph or a pie-chart.

In some disclosed embodiments, data may be assigned, using the assignment module, using one of data aggregation, data splitting, or addition of new data.

Also disclosed are methods for designing digital documents using a computer-based system comprising a set of instructions to cause at least one processor device and related data processing apparatus to operate to provide a method comprising providing a resource module that enables extraction of individual elements of digital resources and storage of the extracted individual elements for use in a design layout, providing a layout module that enables creation of the design layout in a user-customizable manner using design blocks, providing an assignment module that enables assignment of the individual elements to the design blocks to create a design layout, and providing a document creation module that enables the exportation of the design layout to a selectable file format or a selectable medium.

In some disclosed embodiments of the methods the digital resources further comprise HTML-based documents. In further disclosed embodiments of the methods, the digital resources further comprise word-processor documents. In still further disclosed embodiments of the methods, the digital resources further comprise one of computer-aided design flies, database files, desktop publishing files, document files, financial records, graphics, 3D graphics, vector graphics files, photoshop files, presentation files, scientific data, spreadsheet/tabular data, audio files, video files, or web page data, or the like.

In some disclosed embodiments of the methods the design blocks are user-customizable.

In some disclosed embodiments of the methods the design blocks further comprise sub-areas that may be assigned an individual element.

In some disclosed embodiments of the methods selectable data may be assigned, using the assignment module, to a graph design block.

In some disclosed embodiments of the methods the graph design block comprises a bar-graph or a pie-chart.

In some disclosed embodiments of the methods data may be assigned, using the assignment module, using one of data aggregation, data splitting, or addition of new data.

Other embodiments also exist.

### BRIEF DESCRIPTION OF THE DRAWINGS

FIG. 1 is a schematic illustration of system 100 modules in accordance with disclosed embodiments.

FIG. 2 is a schematic illustration of extracting elements for use in digital documents as disclosed herein.

FIG. 3 is a schematic illustration of operation of layout module 106 to design a digital document 200.

FIGS. 4A-4B are schematic illustrations of operation of assignment module 108 in accordance with disclosed embodiments.

FIG. 5. is a schematic illustration of the operation of document creation module 110 in accordance with disclosed embodiments.

FIG. 6A is a schematic flow chart illustrating system 100 modules and their interactions in accordance with disclosed embodiments.

FIG. 6B is a schematic flow chart illustrating a manage resources module 1046 in accordance with disclosed embodiments.

FIGS. 7A-7I are schematic illustrations of system 100 in operation to design a digital document in accordance with disclosed embodiments.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

The disclosed embodiments are described with reference to the method and the apparatus wherein each block in the flowcharts and/or the block diagrams and the combination of various blocks in the flowcharts and/or the block diagrams may be implemented by computer program instructions. These computer program instructions may be provided to a processor of a general computer, a dedicated computer or other programmable data processing apparatus, so as to produce a machine, so that means for implementing functions/operations defined in the blocks in the flowcharts and/or the block diagrams are generated by these instructions executed by the computer or other programmable data processing apparatus.

These computer program instructions may also be stored in a computer readable medium capable of instructing the computer or other programmable data processing apparatus to operate in a specific manner, so that the instructions stored in the computer readable medium generate a product including instruction means for implementing functions/operations defined in the blocks in the flowcharts and/or the block diagrams.

The computer program instructions may also be loaded into the computer or other programmable data processing apparatus, so that a series of operating steps are executed on the computer or other programmable data processing apparatus, to generate a process implemented by the computer, so that the instructions executed on computer or other programmable data processing apparatus provide the processes of the functions/operations defined in the blocks in the flowcharts and/or the block diagrams

A data processing system and/or apparatus, e.g., a computer, can include one or more processors coupled to memory elements through a system bus or other suitable circuitry. As such, the data processing system can store program code within the memory elements. The processor can execute the program code accessed from the memory elements via the system bus. In one aspect, for example, the data processing system can be implemented as a computer that is suitable for storing and/or executing program code. It should be appreciated, however, that the data processing system can be implemented in the form of any system including a processor and memory that is capable of performing the functions and/or operations described within this disclosure.

The memory elements can include one or more physical memory devices such as, for example, local memory and one or more bulk storage devices. The local memory refers to RAM or other non-persistent memory device(s) generally used during actual execution of the program code. The bulk storage device(s) can be implemented as a hard drive or other persistent data storage device. The data processing system also can include one or more cache memories that provide temporary storage of at least some program code in order to reduce the number of times program code must be retrieved from bulk storage device during execution.

Input/output (I/O) devices such as a keyboard, a display, and a pointing device optionally can be coupled to the data processing system. The I/O devices can be coupled to the data processing system either directly or through intervening I/O controllers. One or more network adapters also can be coupled to the data processing system to enable the data processing system to become coupled to other systems, computer systems, remote printers, and/or remote storage devices through intervening private or public networks, Modems, cable modems, and Ethernet cards are examples of different types of network adapters that can be used with the data processing system.

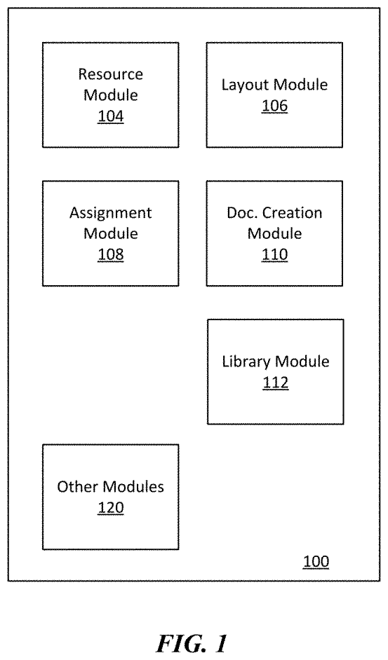

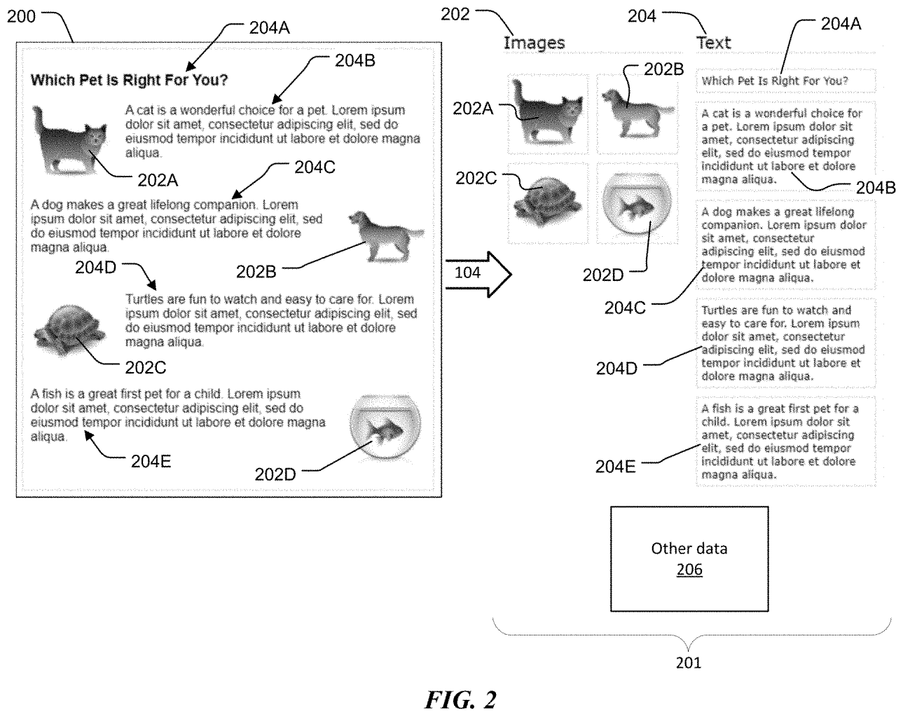

FIG. 1 is a schematic illustration of system 100 modules in accordance with disclosed embodiments. As illustrated, system 100 includes a number of modules that comprise a series of software operating steps that are executed on the computer or other programmable data processing apparatus, to generate a process implemented by the computer, so that the instructions executed on computer or other programmable data processing apparatus provide the processes of the functions/operations defined in the blocks shown in FIG. 2. Resource module 104 comprises instructions and functions to enable a user to specify one or more digital resources from which individual elements are isolated and extracted for later use as described herein. Layout module 106 comprises instructions and functions to enable a user to build/create their target layout/design within which extracted elements can later be placed/assigned. Assignment module 108 comprises instructions and functions to enable a user to assign any number of extracted/created elements to any available target layout design area and data nay also be defined/created/typed/otherwise manually entered in by the user. Further the data (extracted or otherwise procured previously) can be revised/edited. For example, images can be cropped, rotated or otherwise manipulated, and text can be edited as the user sees fit, and so as to meet a user's specific requirements. Document creation module 110 comprises instructions and functions to enable a user to save/export their designed document to the file format/medium of their choosing. For example, in addition to the various file formats, the designed document can also be exported to various mediums such as a web server, website CMS (content management system), database, email, or the like. Embodiments of system 100 may also include a library module 112 that, among other things, stores extracted elements for use/reuse as disclosed herein. As would be apparent to those of ordinary skill in the art having the benefit of this disclosure, other modules 120 with other functions and roles may also be included in system 100.

FIG. 2 is a schematic illustration of extracting elements for use in digital documents as disclosed herein. As illustrated, a digital document 200, such as a webpage, a word processing document, or the like, may contain a number of elements 201, such as images 202A-D, text 204A-E, and the like in a particular layout as shown. By invoking resource module 104 elements 201 are isolated, extracted, and stored as separate files (e.g., using library module 112) of images 202, text 204, other data types 206 (e.g., video, audio, etc.), and the like. Additionally, elements 201 may be stored in a database, stored in computer memory, stored to a remote server, or the like.

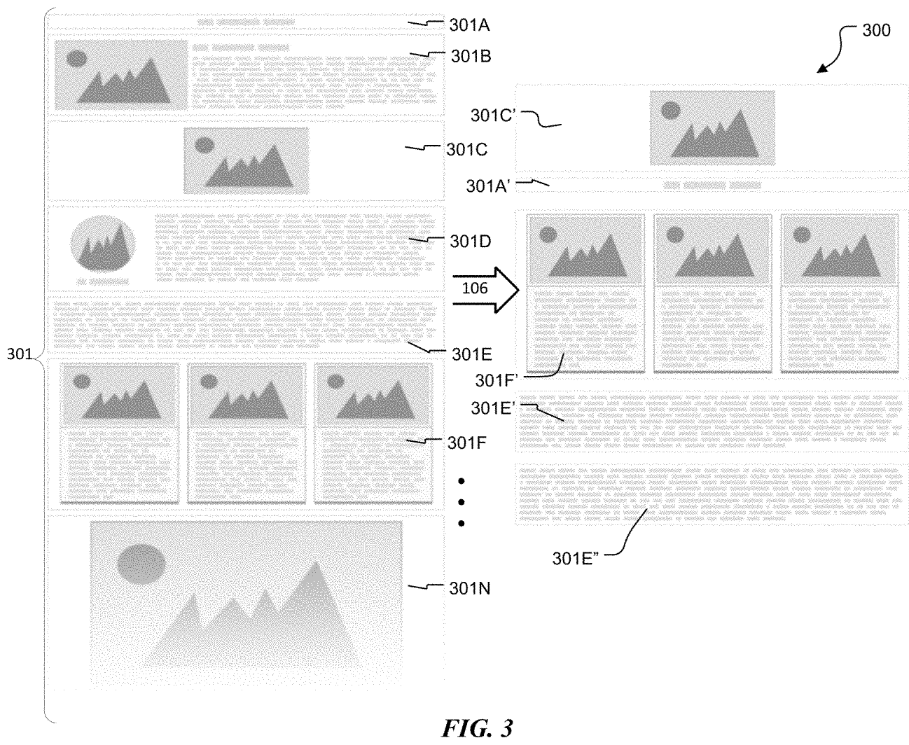

FIG. 3 is a schematic illustration of operation of layout module 106 to design a digital document 200. A user is able to create, by invoking layout module 106, a design layout 300 through the management of the provided design blocks 301. The user is able to add new blocks 301, as well as edit or remove existing blocks 301, so as to achieve their targeted document layout 300 or design. These blocks 301 will later contain the various elements 201 that are contained within the extracted element library, created as new elements 201, or the like. As illustrated, a number of design block 310A, 301B, . . . , 301N may be provided by invoking layout module 106. A user may select design blocks 301 as shown on the right side of FIG. 3 where design blocks 301C′, 301A′, 301F′, 301E′, and 301E″ have been selected and arranged into design layout 300. Selected design blocks 301E′ and 301E″ schematically indicate that a user may select a design block (e.g., design block 301E) more than once, may modify a design block (e.g., 301F′ is an enlarged version of 301F), and the like. In some embodiments, a user's element 201 library can span projects instances. In so doing their future digital documents 200 can easily import data that they have extracted on a previous occasion, even if the project is completely different and unrelated. As persons of ordinary skill in the art having the benefit of this disclosure would comprehend, it can be advantageous to allow library elements 201 to span multiple projects, and it is also very helpful for a design layout 300 to be able to be re-used for future projects.

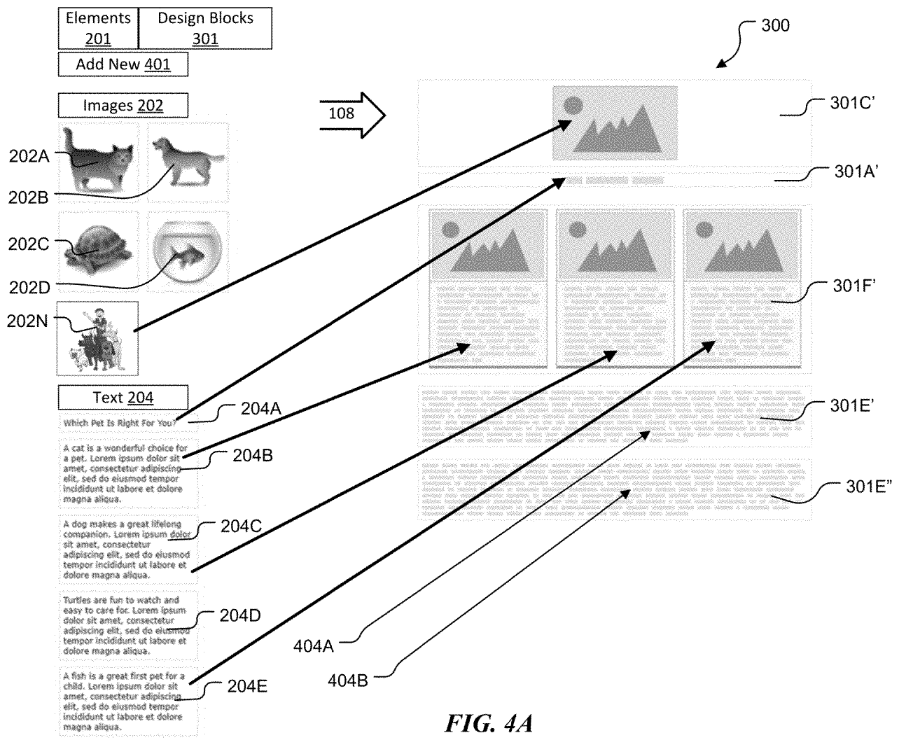

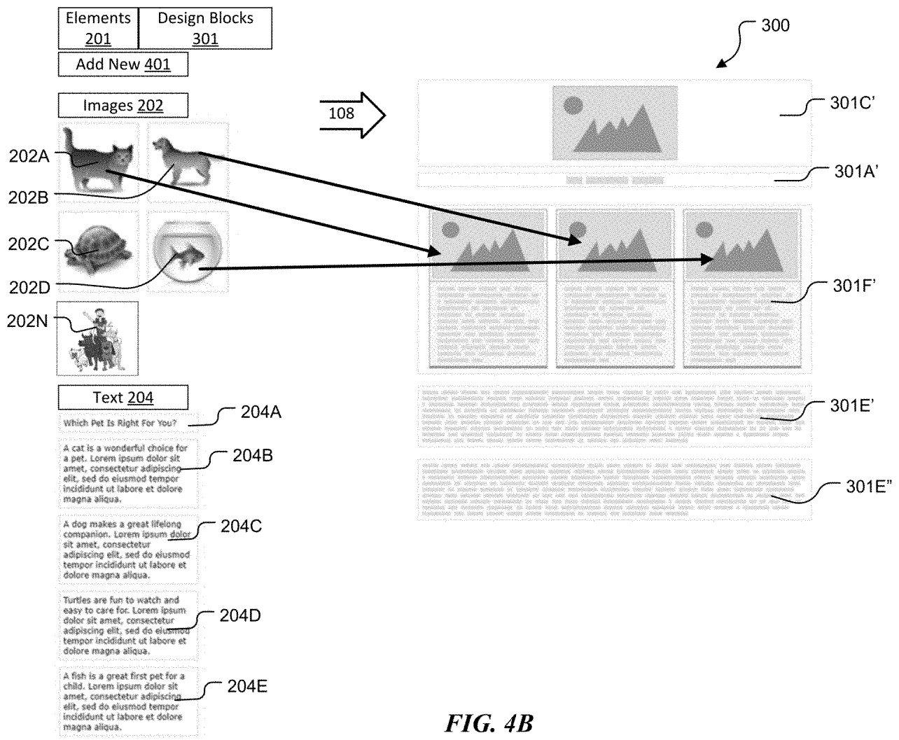

FIGS. 4A-4B are schematic illustrations of operation of assignment module 108 in accordance with disclosed embodiments. As illustrated schematically a user can assign one or more elements 201 from an element library to any of the available layout blocks 301 and their respective sub-areas. Embodiments of system 100 may also enable a user to toggle between elements 201 and design blocks 301 to revise a design layout 300 in an iterative manner. Embodiments of system 100 may also enable a user to add new elements or design block using an add new button 401 or the like. In operation, and indicated schematically by arrows, assignment module 108 enables a user to, for example, assign new image 202N to the image sub-area of design block 301C′. Text 204A may be assigned to text element 301A′. Text elements 204B, 204C, and 204E may be assigned to text sub-areas of design element 301F′. New text elements 404A and 404B may be assigned to design elements 301E′ and 301E″ as indicated. As indicated schematically by arrows in FIG. 4B, image elements 202A, 202B, and 202D may be assigned to image sub-areas of design block 301F′. As one of ordinary skill in the art having the benefit of this disclosure would comprehend, other selections, assignments, and layouts are also possible.

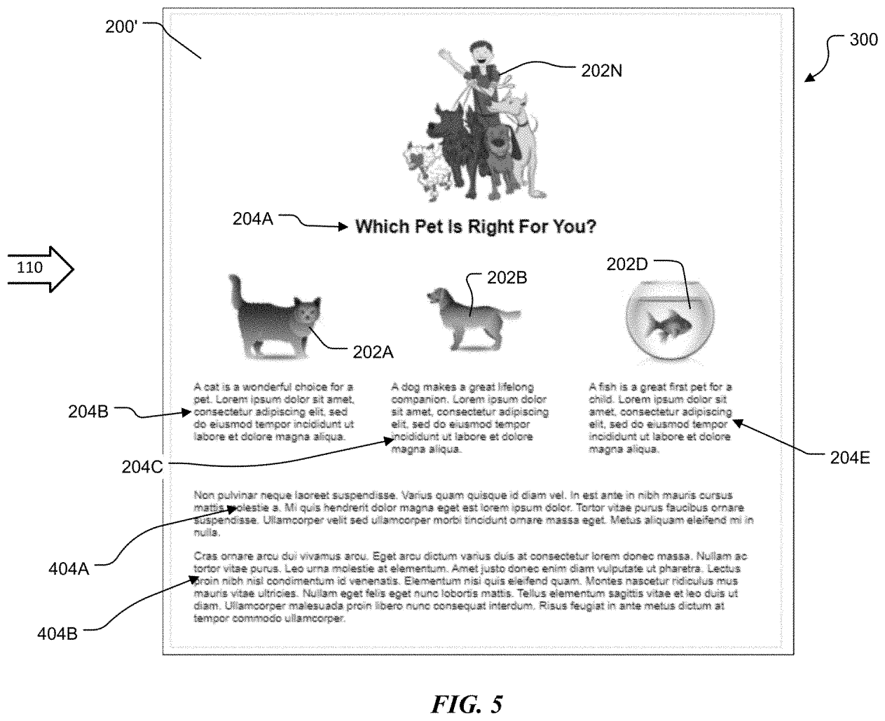

FIG. 5. is a schematic illustration of the operation of document creation module 110 in accordance with disclosed embodiments. As illustrated schematically, by invoking document creation module 110 a user is able to save/export the current design 300 into the format of their choosing to create a new digital document 200′. For example, new document 200′ can be exported as an HTML document for use on a website, can be exported in a word processing format (e.g., MS Word) for use as a printed (paper) document, or the like.

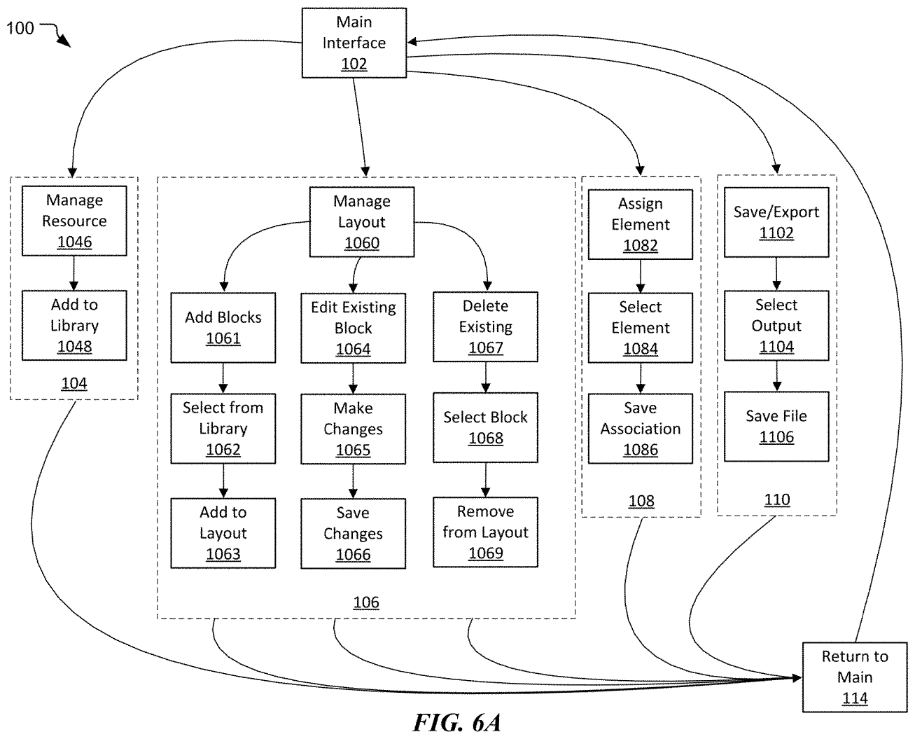

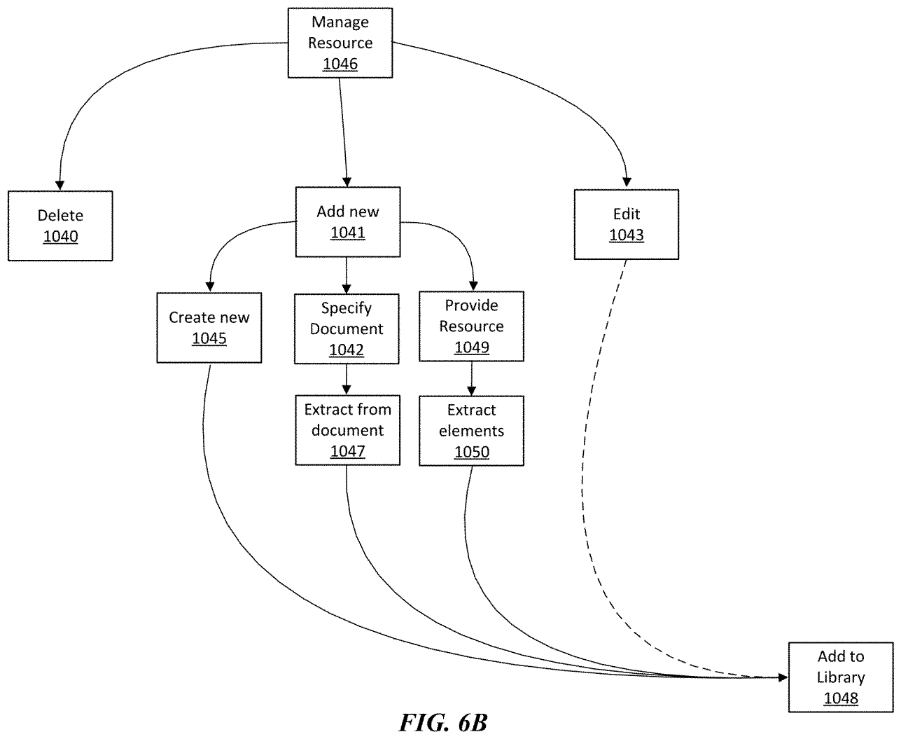

FIG. 6A is a schematic flow chart illustrating system 100 modules and their interactions in accordance with disclosed embodiments. As illustrated, system 100 may include a main interface 102 from which a user may invoke the various modules and functions. For example, from main interface 102, a user may invoke resource module 104. Within resource module 104 various sub-modules enable a user to manage resources 1046 and add resources to a library 1048. FIG. 6B is a schematic flow chart illustrating a manage resources module 1046 in accordance with disclosed embodiments. As illustrated, after invoking the manage resources module 1046, a user may delete 1040 an existing resource, add 1041 a new resource, and edit 1043 an existing resource, which may optionally be added to the library 1048 after editing. As indicated, adding 1041 a new resource may further include creating 1045 a new resource (e.g., by manual typing, uploading an image, etc.), specify a digital document 1042, which may be added to library 1048. Additionally, a user may extract 1047 resources from a digital document 200, provide another resource 1049 (e.g., a graph, database, etc.) from which to extract 1050 elements that can then be added to library 1048.

Returning to FIG. 6A, a user may also invoke layout module 106. Within layout module 106 various sub-modules enable a user to manage a layout 1060, create and add design blocks 1061, select a design block from a library 1062, add a selected design block to a layout 1063, edit an exiting design block 1064, make changes while editing 1065, save changes 1066, delete an existing design block 1067, select a block to be deleted 1068, remove the block from the library 1069, and the like. A user may also invoke assignment module 108. Within assignment module 108 various sub-modules enable a user to assign an element 1082, select an element 1084, and save the association 1086 with the element. A user may also invoke document creation module 110. Within document creation module 110 various sub-modules enable a user to save or export a digital document 1102, select the type of output for the document 1104, and save the file 1106 in the selected format. A user may also return 114 to the main interface 102 as desired. As those of ordinary skill in the art having the benefit of this disclosure would comprehend, other modules, sub-modules, and configurations of the same may also be included in system 100.

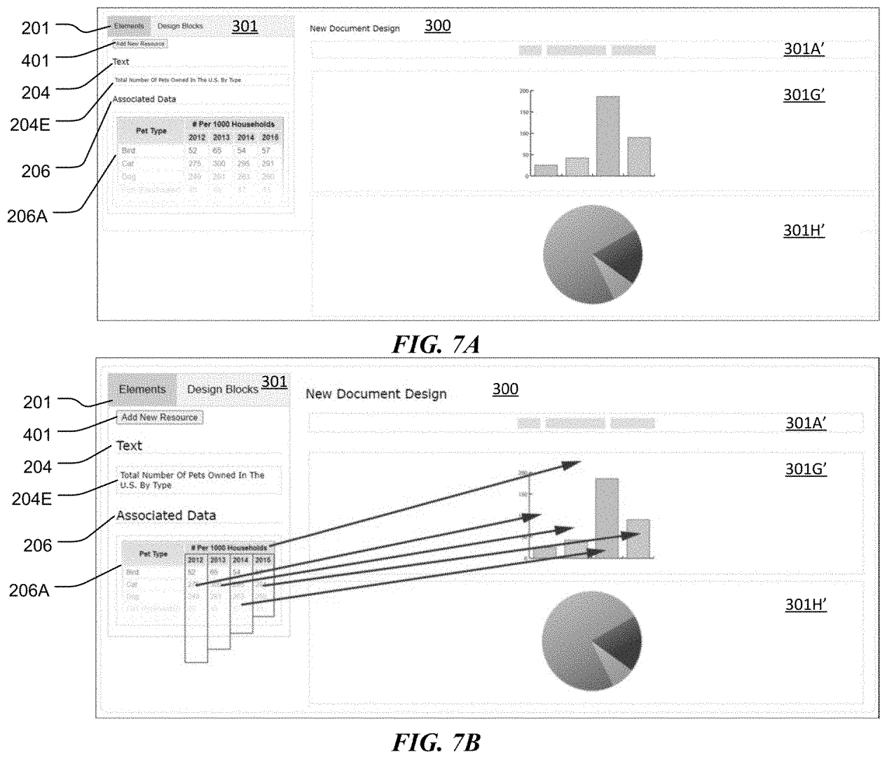

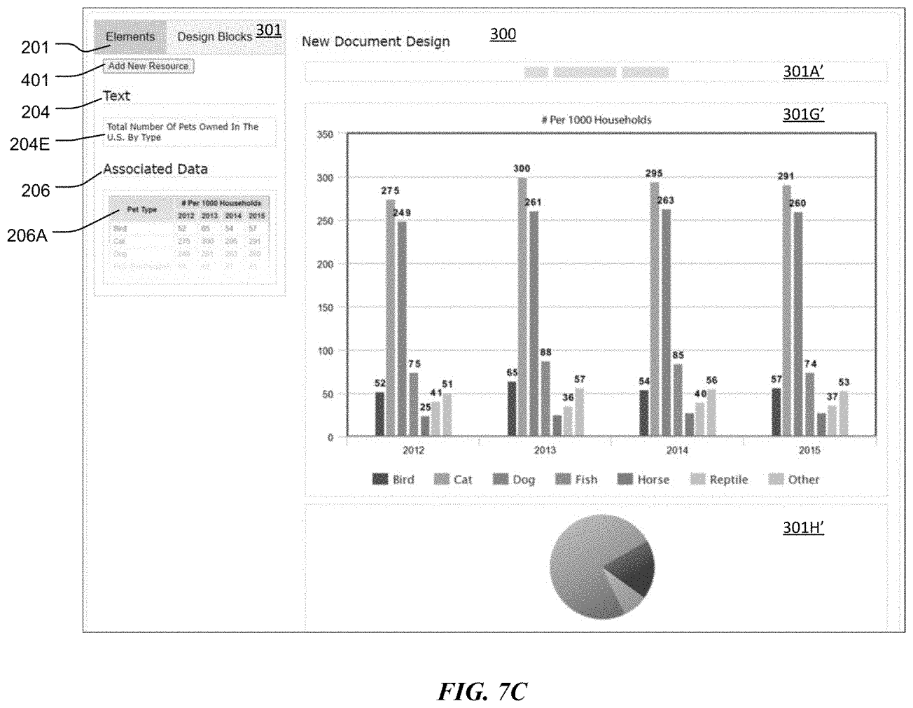

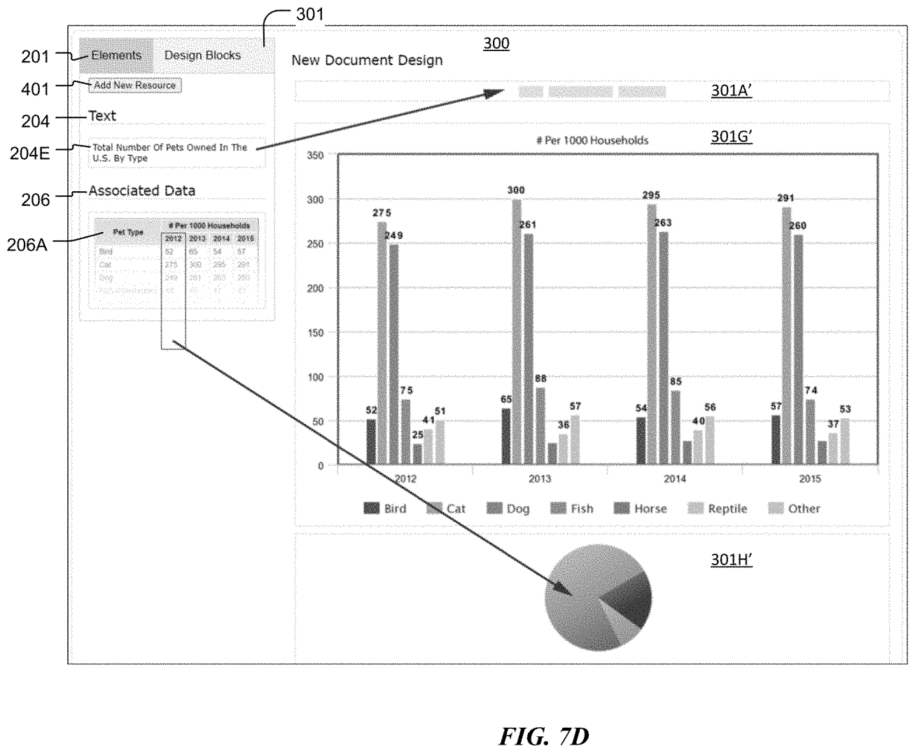

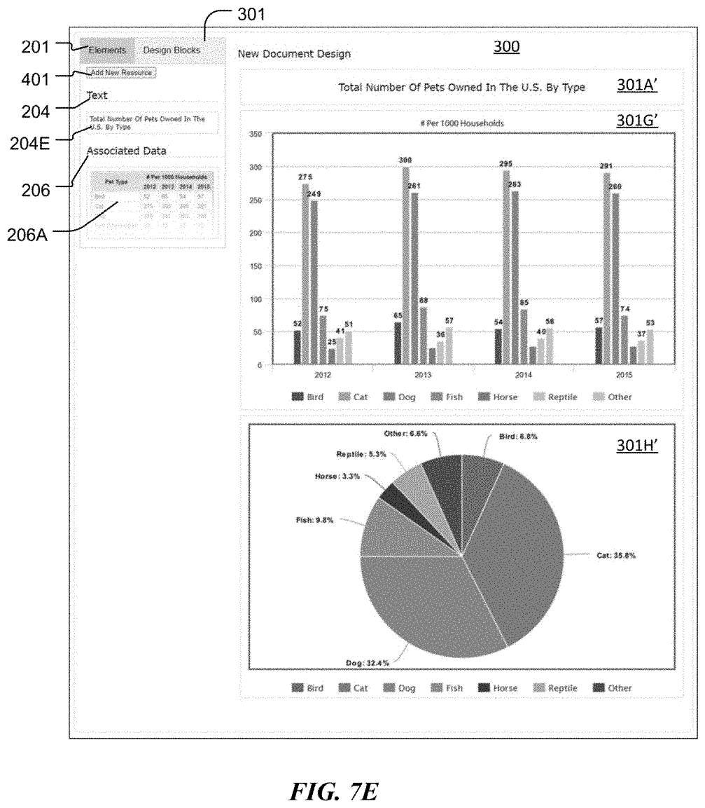

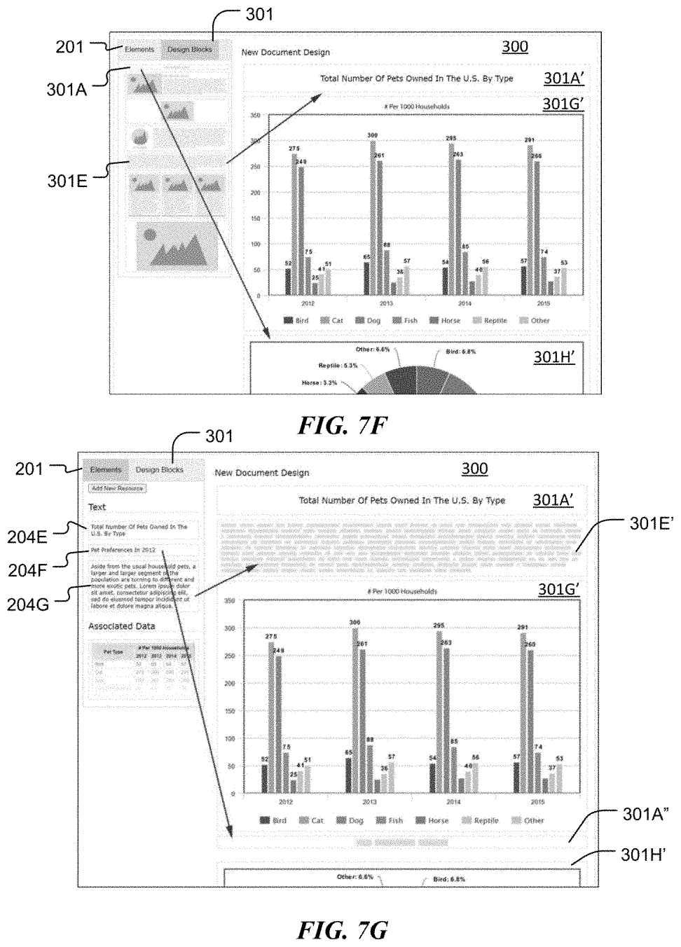

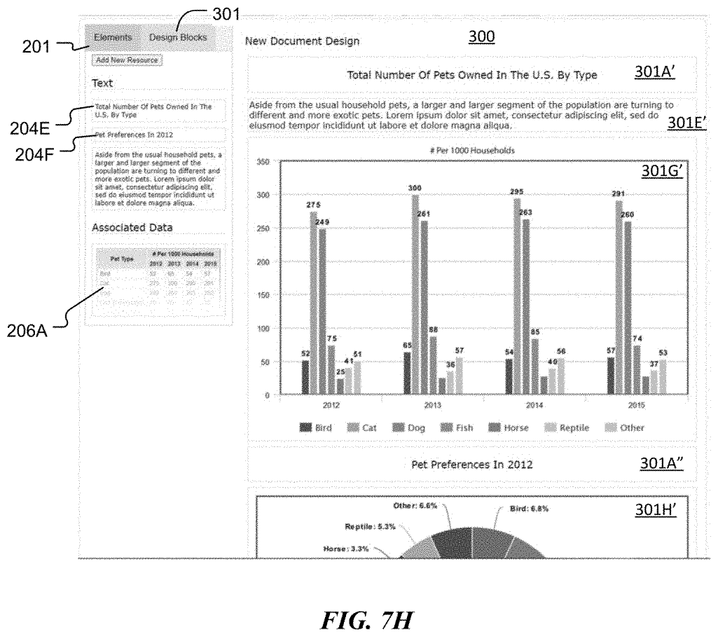

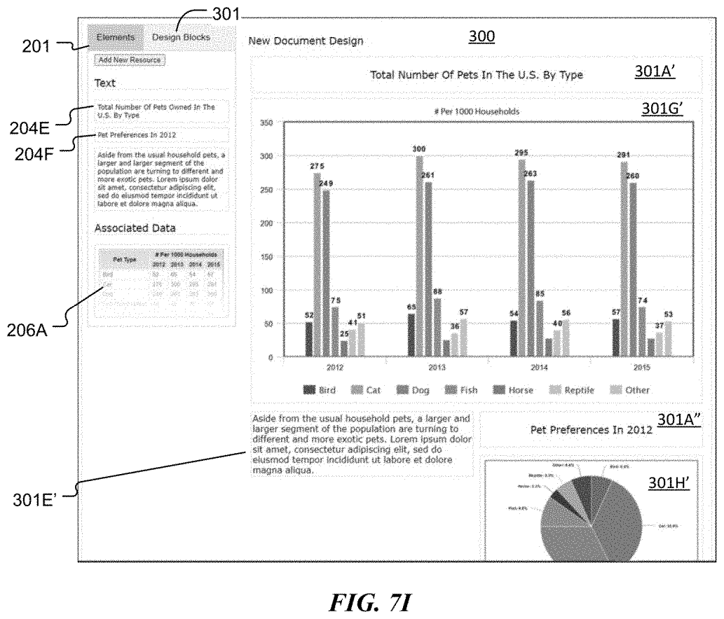

FIGS. 7A-7I are schematic illustrations of system 100 in operation to design a digital document in accordance with disclosed embodiments. As shown in FIG. 7A, a user may use resource module 104 to add a new resource, in this case a data chart 206A to a design layout 300 which includes a text design block 301A′, a bar graph design block 301G′, and a pie chart design block 301H′. As indicated schematically by arrows in FIG. 7B, certain data from data chart 206A may be assigned, using assignment module 108, to bar graph design block 301G′. FIG. 7C indicates schematically the bar graph design block 301G′ with the data from data chart 206A assigned.

FIG. 7D indicates schematically by arrows that select data, in this case just data chart 206A from just the year 2012 may be assigned, using assignment module 108, to pie chart design block 301H′, and text 204E, in this case manually entered by a user, may be assigned to text design block 301A′. FIG. 7E indicates schematically the pie chart design block 301H′ and the text design block 301A′ with the data from data chart 206A assigned and the text 204E assigned, respectively. As persons of ordinary skill in the art having the benefit of this disclosure would understand, in the cases of the assignment of data (e.g., 206) to the various charts, embodiments may employ data aggregation, or the like. For example, data aggregation has been applied to create a “Fish” category of data chart 206A where the original table had data for both freshwater fish and saltwater fish represented individually, and the user is able to combine data sets. Other times a user might want to only use certain data sets and disregard others, for example, a user wants to only graph data for the most common household pets (e.g., cats, dogs, fish, and birds). Additionally, embodiments enable a user to further manipulate the data (e.g., edit the numbers from the original extraction), split existing data sets split a “Reptiles” category into turtles, snakes, and lizards), or add entirely new data sets (e.g., add a data set for Rabbits). Other data manipulations are also possible.

Additionally, as shown schematically in FIGS. 7F-7I new design blocks 301, and additional data (e.g., 202, 204, 206, whether extracted or user defined) can be added to the design 300 at any time. Previously assigned design blocks 301 can be edited, reassigned, or removed completely. Further, design blocks 301 can be re-arranged, and resized at any time as well. For example, FIG. 7F indicates that the design block tab 301 is active and the user has selected a text design block 301A and a paragraph design block 301E to be added to design 300 as indicated schematically by arrows. In FIG. 7G the user has manually entered text 204F, 204G using the elements 201 tab. FIG. 711 shows the assignment of the text 204F, 204G to the respective design blocks 30lA″ and 301E′ in the design 300. Finally, the user has resized and rearranged design blocks 301A″, 301E′, and 301H′ as indicated in FIG. 7I. Other changes are also possible.

Although various embodiments have been shown and described, the present disclosure is not so limited and will be understood to include all such modifications and variations are would be apparent to one skilled in the art.

What is claimed is:

1. A computer implemented system for designing digital documents, the system comprising a set of instructions to cause at least one processor device and related data processing apparatus to operate to provide a system comprising:
a resource module that enables extraction of individual elements of digital resources and storage of the extracted individual elements for use in a design layout;
a layout module that enables creation the design layout in a user-customizable manner using design blocks;
an assignment module that enables assignment of the individual elements to the design blocks to create a design layout; and
a document creation module that enables the exportation of the design layout to a selectable file format or a selectable medium.

2. The computer implemented system of claim 1 wherein the digital resources further comprise HTML-based documents.

3. The computer implemented system of claim 1 wherein the digital resources further comprise word-processor documents.

4. The computer implemented system of claim 1 wherein the digital resources further comprise one of computer-aided design files, database files, desktop publishing files, document files, financial records, graphics, 3D graphics, vector graphics files, photoshop files, presentation files, scientific data, spreadsheet/tabular data, audio files, video files, or web page data.

5. The computer implemented system of claim 1 wherein the design blocks are user-customizable.

6. The computer implemented system of claim 1 wherein the design blocks further comprise sub-areas that may be assigned an individual element.

7. The computer implemented system of claim 1 wherein selectable data may be assigned, using the assignment module, to a graph design block.

8. The computer implemented system of claim 7 wherein the graph design block comprises one of a bar-graph, a pie-chart, a line chart, an area chart, a scatter chart, a bubble chart, a gauge, a heat map, a tree map, a timeline, a histogram, or a bell curve.

9. The computer implemented system of claim 1 wherein data may be assigned, using the assignment module, using one of data aggregation, data splitting, or addition of new data.

10. A method for designing digital documents using a computer-based system comprising a set of instructions to cause at least one processor device and related data processing apparatus to operate to provide a method comprising:
providing a resource module that enables extraction of individual elements of digital resources and storage of the extracted individual elements for use in a design layout;
providing a layout module that enables creation the design layout in a user-customizable manner using design blocks;
providing an assignment module that enables assignment of the individual elements to the design blocks to create a design layout; and
providing a document creation module that enables the exportation of the design layout to a selectable file format or a selectable medium.

11. The computer implemented method of claim 10 wherein the digital resources further comprise HTML-based documents.

12. The computer implemented method of claim 10 wherein the digital resources further comprise word-processor documents.

13. The computer implemented method of claim 10 wherein the digital resources further comprise one of computer-aided design files, database files, desktop publishing files, document files, financial records, graphics, 3 graphics, vector graphics files, photoshop files, presentation files, scientific data, spreadsheet/tabular data, audio files, video files, or web page data.

14. The computer implemented method of claim 10 wherein the design blocks are user-customizable.

15. The computer implemented method of claim 10 wherein the design blocks further comprise sub-areas that may be assigned an individual element.

16. The computer implemented method of claim 10 wherein selectable data may be assigned, using the assignment module, to a graph design block.

17. The computer implemented method of claim 16 wherein the graph design block comprises one of a bar-graph, a pie-chart, a line chart, an area chart, a scatter chart, a bubble chart, a gauge, a heat map, a tree map, a timeline, a histogram, or a bell curve.

18. The computer implemented method of claim 10 wherein data may be assigned, using the assignment module, using one of data aggregation, data splitting, or addition of new data.
